(19) United States
(12) Patent Application Publication
(10) Pub. No.: US 2015/0222710 A1
(43) Pub. Date: Aug. 6, 2015

(54) POLICY DECISION POINT MANAGEMENT

(71) Applicants: Mu-Jin Liu, Shanghai (CN); Martin Schwarze, Burnaby (CA); Zhi-Jie Dai, Shanghai (CN); Gan Li, Shanghai (CN)

(72) Inventors: Mu-Jin Liu, Shanghai (CN); Martin Schwarze, Burnaby (CA); Zhi-Jie Dai, Shanghai (CN); Gan Li, Shanghai (CN)

(73) Assignee: HEWLETT-PACKARD DEVELOPMENT COMPANY, L.P., Houston, TX (US)

(21) Appl. No.: 14/420,255

(22) PCT Filed: Sep. 13, 2012
(86) PCT No.: PCT/CN2012/081329

§ 371 Date: Apr. 24, 2015

(51) Int. Cl. H04L 29/08; H04L 12/24

(52) U.S. Cl. CPC H04L 67/141; H04L 41/50

(57) ABSTRACT

A UPM system may include a session manager module to establish interface sessions with a policy enforcement point (PEP) and a policy decision point (PDP). A notification manager module forward event information received from the PEP to the PDP and receive a policy decision from the PDP. A policy engine may determine, based on the event information, whether to forward the policy decision to the PEP, to ignore the policy decision or to modify the policy decision.

### BACKGROUND

Data traffic growth is very rapid in networks, especially in mobile networks, such as 3G, Long Term Evolution (LTE), and emerging mobile networks. Service providers often seek updated solutions that are capable of enforcing policies to manage consumption of network resources, and attempt to combine existing and updated solutions in their networks.

### BRIEF DESCRIPTION OF DRAWINGS

The embodiments are described in detail in the fall wing description with reference to examples shown in the following figures.

FIG. 1 illustrates a unified policy management (UPM) system.

FIG. 2 illustrates a UPM system in a general packet radio system network.

FIGS. 3-9 illustrate methods.

FIG. 10 illustrates a computer system that may be used for the method and systems.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a UPM system manages information and messages directed to a policy decision point (PDP) from network elements, which may include policy enforcement points (PEPs). For example, the UPM system receives messages and information from a PEP and sends it to the PDP. The PDP may make a policy decision based on the information. The policy decision may be for a policy enforced or to be enforced by the PEP. The UPM system receives the policy decision and decides whether to forward the policy decision to the PEP, to modify the policy decision or to ignore the policy decision.

The PDP is a functional element that makes policy control decisions and may be considered a policy decision point for network elements. The policy decisions may be for policies related to the management of consumption of network resources, such as quality of service (QoS), service level policies for applications, etc. The PEP is an enforcement point for enforcing the policies.

In one example, the PDP may be a legacy PDP which may reside on a server external to the UPM system. The legacy PDP may have limited policy decision capabilities. For example, the legacy PDP may be a first generation PDP at focuses on metric level policies but does not take into account application level policies or subscriber level policies, such as policies for implementing subscriber tier-based quality of service (QoS) policies. The UPM system includes an extended PDP to provide extended policy decisions and to operate with the legacy PDP to provide the desired policy decision making.

In one example, the UPM system, the PEP and the PDP are employed in a 3rd Generation Partnership Project (3GPP) network to enforce subscriber level or service level policies. The UPM system may be used in a General Packet Radio Service (GPRS), Universal Mobile Telecommunications System (UMTS) or a Long Term Evolution (LTE) network. The PEP may be a policy and charging enforcement function (PCEF) and the PDP may be a policy and charging rules function (PCRF). Examples of the policies may include enforcing, different QoS limitations for different subscribers (e.g., bearer level QoS). For example, bearer level QoS policies define the policies for all of the packets passing through the bearer. Other policies may be service level policies associated with layers 1-3 of the Open Systems Interconnection (OSI) model or associated with layers 4-7 with the help of deep packet inspection. These policies may include peer-to-peer (P2P) service policies. In the 3GPP network, the PEP may be a PCEF, which is a functional element that encompasses policy enforcement and charging functionalities. The PCEF may reside at a gateway node and manage traffic at the gateway node and QoS. The PCRF encompasses policy control decision and flow based charging control functionalities. The PCRF makes policy decisions for policies enforced by the PCEF. For example, the PCRF provides network control regarding the service data flow detection, gating, QoS and flow based charging towards the PCEF, and provisions policies to the PCEF.

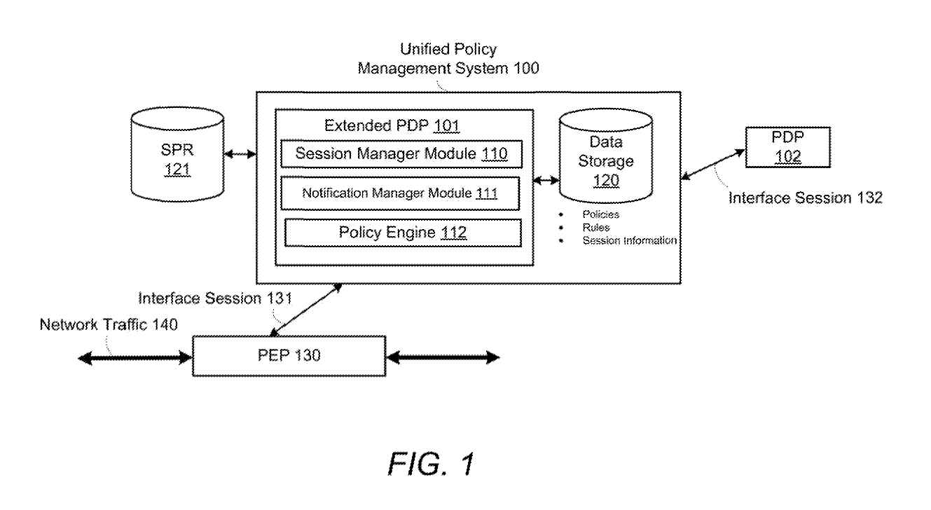

FIG. 1 illustrates a UPM system 100. The UPM system 100 includes an extended PDP 101 that interacts with PDP 102 and PEP 130. In one example, the PDP 102 is a legacy PDP, which may have been installed prior to the extended PDP 102. The extended PDP 101 may include a session manager module 110, a notification manager module 111 and a policy engine 112. The UPM system 100 may include a data storage 120. The data storage 120 may include a database or another type of data storage system that stores any information used by the UPM system 100. Examples of some of the information stored in the data storage 120 may include policies, rules, and session information. The UPM system 100 may comprise hardware, machine readable instructions or a combination of hardware and machine readable instructions. The machine readable instructions may be stored on a storage device and executed by one or more processors.

Network traffic 140 for one or more networks may be received by the PEP 130. The PEP 130 may enforce different polices for the network traffic 140, such as subscriber-based QoS polices, charging policies, etc. The session manager 110 establishes interface sessions 131 and 132 with the PEP 130 and the PDP 102, respectively. Session information is stored in the data storage 120 for each interface session 131 and 132. The session information may include one or more of a session identifier, subscriber identifier, etc. The interface sessions 131 and 132 may be for the same subscriber and carry policy-related information for traffic for the same subscriber. The interface sessions 131 and 132 may use a protocol to communicate between the extended PDP 101 and the PEP 130 and the PDP 102. In one example, the protocol used by the interface sessions is the diameter protocol. The interface sessions 131 and 132 may be Gx sessions for Gx reference points in a 3GPP core network as described in further detail below. The interface sessions 131 and 132 may carry signaling data for policy and charging rules for a particular subscriber.

The session manager module 110 also manages the interface sessions 131 and 132. For example, when establishing the interface session 131, the session manager module 110 also establishes the interface session 132. Furthermore, if the interface session 131 times out or is otherwise terminated, the session manager module 110 terminates the interface session 132.

The notification manager module 111 sends and receives messages for the extended PDP 101. The messages may be from or to the PEP 130 or the PDP 102, and may be sent via the interface sessions 131 and 132. The notification manager module 111 may receive event notifications including event information about events detected at the PEP 130. The events may be associated with policies enforced by the PEP 130 and conditions for triggering enforcement of different policies. For example, an event may be a change in location of a subscriber. Many more types of events may be subscribed to by the notification manager module 111. When, these events are detected, a policy change may be facilitated by the extended PDP 101 and the PDP 102. For example, the extended PDP 101 receives an event notification from the PEP 130 via interlace session 132. The notification manager module 111 sends the event information to the PDP 102 via the interface session 132 if PDP 102 subscribes this kind of event. The PDP 102 makes a policy decision based on the event information. For example, the to PDP 102 decided to reduce the QoS for the subscriber. The policy decision is sent to the extended PDP 102 via the interface session 132. The policy engine 112 decides whether to ignore, modify or forward the policy decision based on the rules stored in the data storage 120 and/or subscriber profile information retrieved from the subscriber profile repository (SPR) 121. A modified policy decision or the same policy decision from the PDP 102 may be sent to the PEP 130 for enforcement via the interface session 131. The extended PDP 101 may operate as an intermediary between the PEP 130 and the PDP 102 and make addition policy decisions that are not supported by the PDP 102.

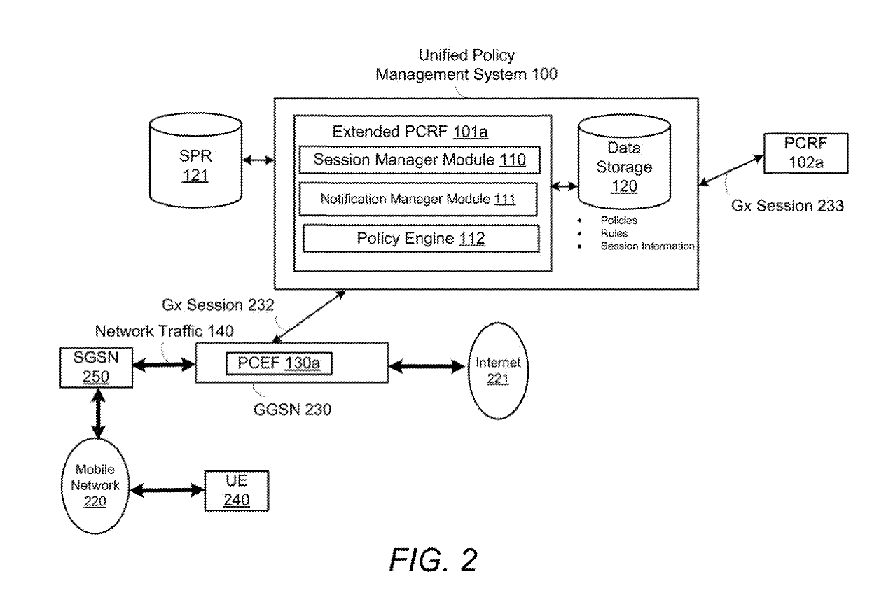

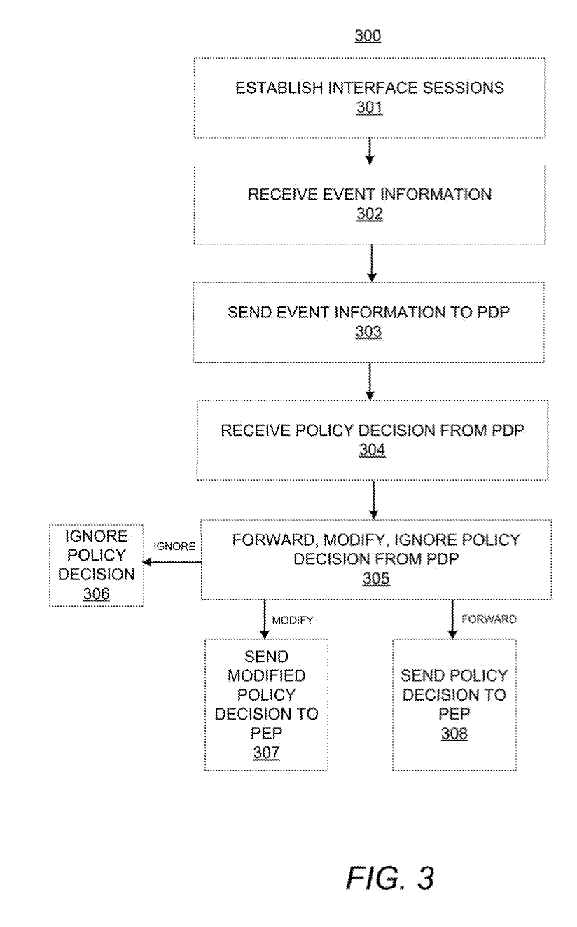

FIG. 2 shows an example of the UPM system 100 used in a General Packet Radio Service (GPRS) network. For example, PEP 130 may be PCEF 130a and resides in a gateway service node. The gateway service node may be a routing point between mobile network 220, such as a Global System for Mobile (GSM) network (e.g., 2G, 3G, 4G), and the Internet 221 or some other Internet Protocol (IP) network. In the example shown in FIG. 2 the gateway service node is GPRS support node (GGSN) 230. Also, PDP 101 and PDP 102 may be a PCRF 101a and a PCRF 102a as shown in FIG. 3. PCEF 130 in the GGSN 230 may enforce subscriber-based QaS policies or other types of policies. For example, user equipment (UE) 240 is for a particular subscriber and maximum uplink and downlink bandwidths are enforced for the UE 240. Also, Gx sessions 232 and 233 may be established by the session manager module 110 for communicating between the extended PCRF 101 and the PCEF 130 and the PCRF 102. In this example, the interface sessions 131 and 132 are the Gx sessions 232 and 233 for Gx reference points. The Gx sessions 232 and 233 carry policy control and charging control signaling data. For example, the Gx sessions 232 and 233 carry signaling data for provisioning and removal of Policy and Charging Control (PCC) rules from the extended PCRF 101 to the PCEF 13- and the transmission of traffic plane events from the PCEF 130 to the extended PCRF 101. The Gx sessions 232 and 233 can be used for charging control, policy control or both by applying Attribute Value Pairs (AVPs) relevant to an application.

Serving GPRS support node (SGSN) 250 delivers data packets from and to mobile stations within its geographical service area. Its tasks include packet routing and transfer, mobility management (attach/detach and location management), logical link management, and authentication and charging functions. Instead of GGSN 230 and SGSN 250, the system shown in FIG. 2 may include a PGW for the GGSN 230 and a Serving Gateway (SGW) instead of the SGSN 250 for a 4G LTE network.

The policy engine 112 facilitates policy management between the extended PCRF 101, the PCRF 102 and the PCEF 130. For example, the GGSN 230 may detect a radio access technology (RAT) change from 3G to 2G and sends a notification event message via Gx session 232 to the extended PCRF 101. The notification manager module 111 sends the event information to the PCRF 102 and may receive a policy decision from the PCRF 102. The policy engine 112 may send the policy decision to the PCEF 130 or send a modified policy decision or not send any change in policy to the PCEF 130 depending on policy rules.

FIG. 3 illustrates a method 300. The method 300 is described with respect to the UPM system 100 shown in FIGS. 1 and 2 by way of example. At 301, interface sessions are established between the PEP 130 and the extended PDP 101, and between the extended PDP 101 and the PDP 102. For example, interface sessions 131 and 132 are established. Establishing the interface sessions may be facilitated by the session manager module 110. The interface sessions, for example, are for the same subscriber. The interface sessions 131 and 132 may include Gx sessions for 3GPP Gx reference points as shown in FIG. 2. As part of 301, an initial policy rule may be provisioned to the PEP 130.

At 302, the extended PDP 101 receives event information from the PEP 130. The event information may include information about network traffic 140 received at the PEP 130. The event information may include events detected by the PEP 130, such as a location change of a subscriber, RAT change, or some other events associated with the network traffic 140 for a particular subscriber. The network traffic 140 may include a service data flow for the subscriber that is received at the PEP 130. The service data flow may include IP packets related to a user service, such as web browsing, email, etc. The PEP 130 may also determine information about the subscriber.

At 303, the extended PDP 101 sends the event information to the PDP 102. For example, the notification manager module 111 sends the event information to the PDP 102.

At 304, the extended PDP 101 receives a policy decision from the PDP 102. The policy decision may be related to the subscriber, subscriber services, QoS, etc. The policy decision may be based on the event information. For example, if the event is a change in subscriber location, the policy decision may be to downgrade the subscriber QoS at the PEP 130. Another policy decision may be to do nothing based on the event. Policy decisions of the PDP 102 may be related to a PCC rule, QoS per QoS Class Identifier (QCI), QoS per IP-Connectivity Access Network (CAN) bearer, QoS per Access Point Name (APN), Event Trigger, Revalidation-Time, etc.

At 305, the extended PDP 101 determines whether to forward the policy decision from the PDP 102, modify the policy decision or ignore the policy decision. The determination, which may be performed by the policy engine 112, and may be based on rules stored in the data storage 120. The rules may specify conditions for implementing different polices and in some instances the policy decisions differ from the decisions that are made by the PDP 101 based on the same event. For example, the extended PDP 101 may implement subscriber tier-based QoS policies that are not done by the PDP 102.

If the policy decision of the PDP 102 is ignored at 305, the extended PDP 101 does not send the policy decision from the PDP 102 to the PEP 130. Instead, the policy decision is ignored.

If the policy decision of the PDP 102 is modified at 305, the modified policy decision is sent to the PEP 130 for execution at 307.

If the policy decision of the PDP 102 is to be implemented, the policy decision made by the PDP 102 is sent from the extended PDP 101 to the PEP 130 for execution at 308.

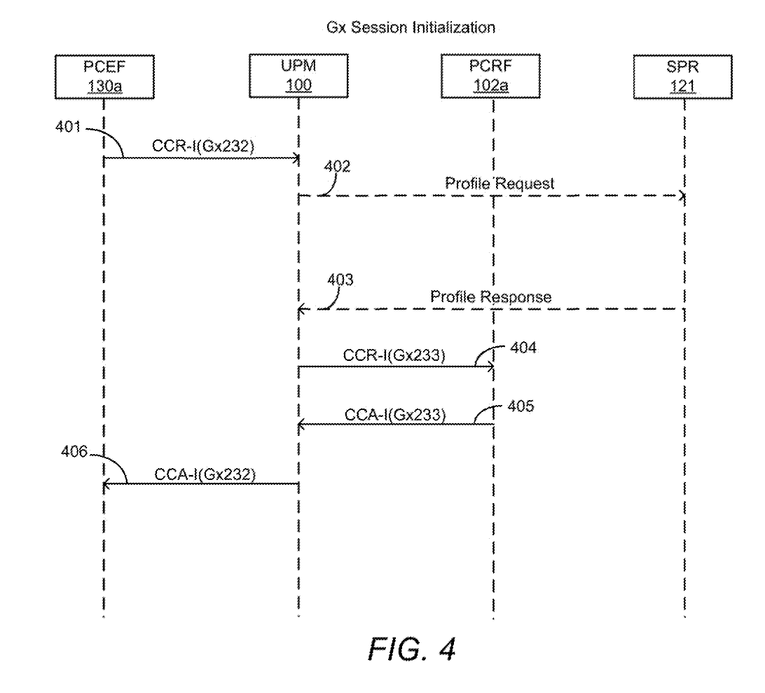

FIGS. 4-9 show methods that are described by way of example with respect to FIG. 2. FIG. 4 illustrates establishing Gx sessions 232 and 233. At 401, the PCEF 130A sends a Credit Control Request (CCR-I because its “Initial_Request”) to the extended PCRF 101a to establish the Gx session 232. At 402, the extended PCRF 101a (e.g., in the UPM system 100 and shown as UPM 100 in FIGS. 4-9) sends a subscriber profile request to the SPR 121, whereby the subscriber may be the user of the UE 240. At 403, the SPR 121 sends a profile response back to the extended PCRF 101a that includes information for the subscriber, i.e., subscriber profile. At 404, the extended PCRF 101a sends a CCR-I to the PCRF 102a. At 405, the PCRF 102a responds with a Credit Control Answer (CCA-I) which may indicate that the Gx reference point is acknowledged and the Gx session 233 is established between the extended PCRF 101a and the PCRF 102a. At 406, the extended PCRF 101a sends a CCA-I to the PCEF 130a to establish the Gx session 232. FIG. 4 shows that the Gx session 233 is first attempted to be established in response to the CCR-I from the PCEF 130a. If the Gx session 233 is established, then the Gx session 232 is established. If for some reason, the Gx session 233 is unable to be established, the extended PCRF 10l a may not establish the Gx session 232.

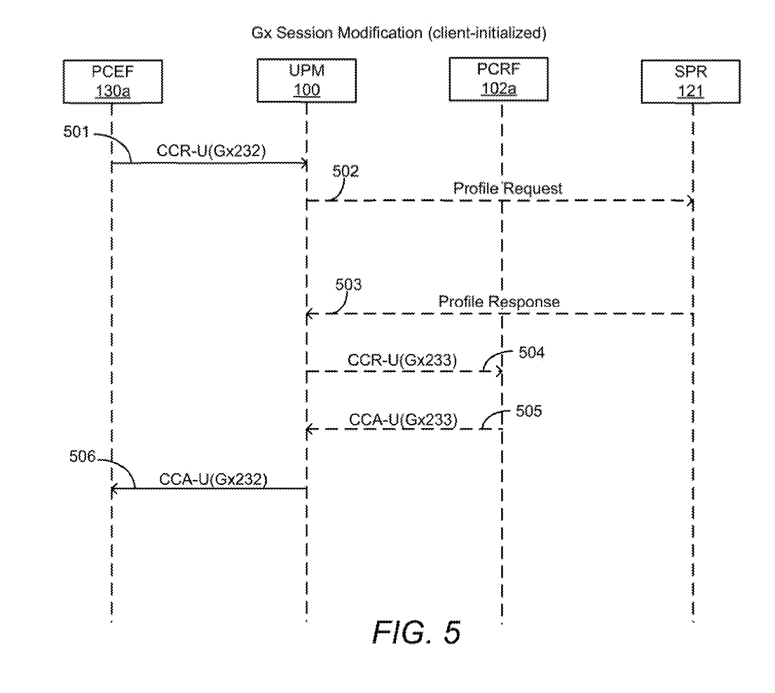

FIG. 5 shows a client-initialized modification to a Gx session after the GX sessions 232 and 233 are established such as described in FIG. 4. At 501, the PCEF 130a sends CCR update request (CCR-U) via Gx 232 to the extended PCRF 101. The CCR-U may be sent, far example, if policies, such as policy control and charging (FCC) rules, need to be updated. At 502, the extended PCRF 101a sends a profile request to the SPR 121 for the subscriber, which may be the user of the UE 240. At 503, the SPR 121 sends a profile response back to the extended PCRF 101a that includes information for the subscriber. The profile information may be used to determine whether to update a policy. The extended PCRF 101a may determine the policy is to be updated. At 504, the extended PCRF 101a sends CCR-U via Gx 233 to the PCRF 102A. At 505, the PCRF 102a sends a Credit Control Answer Update (CCA-U) to the extended PCRF 101a via GX session 233. The CCA-U may indicate the update was performed at the PCRF 102a. At 506, the extended PCRF 101a sends CCA-U to the PCEF 130a via Gx session 232, for example, to indicate the update was performed.

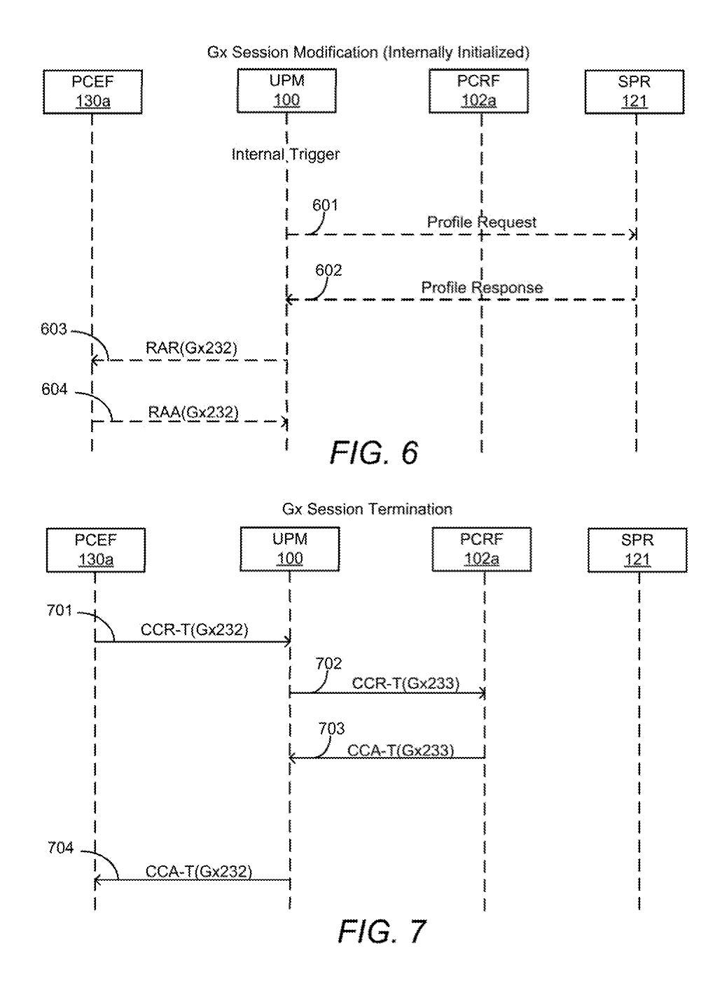

FIG. 6 shows an internally triggered Gx session modification by the extended PCRF 101. The PCRF 102A is not involved. An internal trigger in the extended PCRF 101a may be caused by a variety of reasons. For example, the extended PCRF 101a may get subscriber profile information from the SPR 121 at 601 and 602. The profile information may indicate a change in the subscription, such as the subscriber has subscribed to a higher QoS. The extended PCRF 101a sends a Re-Auth-Request (RAR) to the PCEF 130a via Gx session 232 to change the QoS policy enforced by the PCEF at 603. At 604, PCEF 130a responds with a Re-Auth-Acceptance (RAA), which, for example, indicates that the policy change was implemented.

FIG. 7 illustrates termination of Gx session. For example, if the subscriber drops a data session on the UE 240 or some other termination event occurs, the PCEF 130a sends terminate request (CCR-T) to the extended PCRF 101a via Gx session 232 at 701. The extended PCRF 101a then terminates Gx session 233. For example, at 702, the extended PCRF 101a sends CCR-T to the PCRF 102a via Gx session 233 and the PCRF 102a responds with CCA-T at 703 to terminate Gx session 233. Once Gx 233 is terminated, the extended PCRF 101a terminates Gx session 232 by sending CCR-T to PCEF 130A at 704.

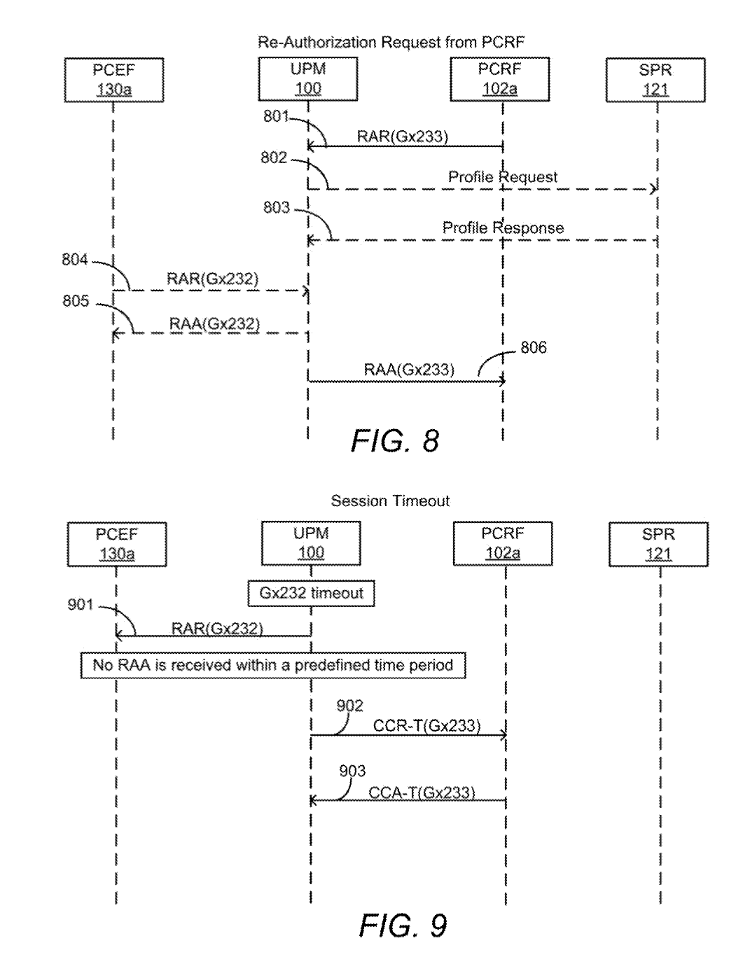

FIG. 8 illustrates a re-authorization request from the PCRF 102a. For example, the PCRF 102a may detect a network level event. For example, the PCRF 102a gets congestion information from a monitoring system and decides to change policies in the network that are enforced by the PCEF 130A based on the congestion. At 801, the PCRF 102a sends RAR to the extended PCRF 101a via Gx session 233. At 802-803, the extended PCRF 101a gets profile information for the subscriber to decide whether to change the policy at the PCEF 130A. If the policy is to be changed, at 804-805, the extended PCRF 101a sends the RAR to the PCEF 130a and receives an answer (RAA) from the PCEF 130a via Gx session 232. At 806, the extended PCRF 101a sends RAA to the PCRF 102a, for example, to indicate a policy update was performed at the PCEF 130a.

FIG. 9 illustrates a Gx session timeout. For example, a Gx session may timeout if the PCEF 130a has not received an update in a certain amount of time. Then, Gx session 233 may be terminated. For example, after a timeout, the extended PCRF 101a sends RAR to the PCEF 130a at 901. If RAA is not received within a predefined time period, then at 902, the extended PCRF 102a sends CCR-T to the PCRF 102A to terminate Gx session 233. At 903, the PCRF 102a responds with CCA-T.

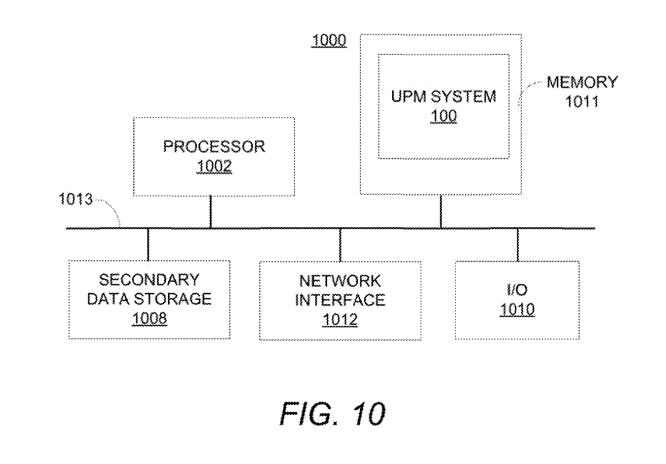

FIG. 10 shows a computer system 1000 that may be used with the embodiments described herein. The computer system 1000 represents a generic platform that includes components that may be in a server or another computer system. The computer system 1000 may be used as a platform for the data storage system 100. The computer system 1000 may execute, by one or more processors or other hardware processing circuits, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 1000 includes a processor 1002 that may implement or execute machine readable instructions performing some or all of the methods, functions and other processes described herein. Commands and data from the processor 1002 are communicated over a communication bus 1013. The computer system 1000 also includes a main memory 1011, such as a random access memory (RAM), where the machine readable instructions and data for the processor 1002 may reside during runtime, and a secondary data storage 1008, which may be non-volatile and stores machine readable instructions and data. For example, machine readable instructions for the UPM system 100 may reside in the memory 1011 during runtime. The memory 1011 and secondary data storage 1008 are examples of computer readable mediums.

The computer system 1000 may include an I/O device 1010, such as a keyboard, a mouse, a display, etc. For example, the I/O device 1010 includes a display to display drill down views and other information described herein. The computer system 1000 may include a network interface 1012 for connecting to a network, Other known electronic components may be added or substituted in the computer system 1000.

While the embodiments have been described with reference to examples, various modifications to the described embodiments may be made without departing from the scope of the claimed embodiments.

What is claimed is:

1. A unified policy management (UPM) system comprising:
a session manager module to establish a first interface session with a policy enforcement point (PEP) and to establish a second interface session with a policy decision point (PDP);
a notification manager module to receive, from the PEP via the first interface session, event information associated with network traffic received at the PEP, and to send the event information to the PDP via the second interface session; and
a policy engine, executed by a processor, to receive a policy decision from the PDP and determine, based on the event information, whether to forward the policy decision to the PEP, to ignore the policy decision or to modify the policy decision.

2. The UPM system of claim 1, wherein if the policy engine determines the policy decision is to be forwarded to the PEP, the notification manager is to send the policy decision to the PEP,
if the policy engine determines the policy decision is to be modified, the notification manager module is to send a modified policy decision to the PEP, and
if the policy engine determines the policy decision is to be ignored, no message is sent to the PEP for modifying a policy enforced at the PEP.

3. The UPM system of claim 1, wherein the PDP is a legacy PDP that does not have policy decision capability of the UPM system.

4. The UPM system of claim 1, wherein the legacy PDP is not informed that the policy decision is sent to the UPM system.

5. The UPM system of claim 1, wherein the session manager module is to establish the second interface session prior to the first interface session.

6. The UPM system of claim 1, wherein if the UPM system receives a terminate request message from the PEP for the first interface session, the UPM system is to terminate the second interface session.

7. The UPM system of claim 1, wherein if the first interface session times out, the UPM system is to terminate the second interface session.

8. The UPM system of claim 1, wherein the first and second interface sessions are Gx sessions.

9. The UPM system of claim 8, comprising an extended PDP providing policy decision capabilities not performed by the PDP.

10. A non-transitory computer readable medium including machine readable instructions executable by at least one processor to:
establish a first interface session with a PEP and to establish a second interface session with a PDP;
receive, from the PEP via the first interface session, event information associated with network traffic received at the PEP;
send the event information, to the PDP via the second interface session;
receive a policy decision from the PDP; and
determine, based on the event information, whether to forward the policy decision to the PEP, to ignore the policy decision or to modify the policy decision.

11. The non-transitory computer readable medium of claim 10, wherein the machine readable instructions are executable by the at least one processor to:
forward the policy decision to the PEP if the policy decision is determined to be forwarded;
send a modified policy decision to the PEP if the policy decision is determined to be modified; and
not to send a message to the PEP to modifying a policy enforced at the PEP if the policy decision is determined to be ignored.

12. The non-transitory computer readable medium of claim 10, wherein the PDP is a legacy PDP that does not have policy decision capability of a UPM system that performs the determination of whether to forward the policy decision to the PEP, to ignore the policy decision or to modify the policy decision.

13. The non-transitory computer readable medium of claim 10, wherein the second interface session is established prior to the first interface session.

14. The non-transitory computer readable medium of claim 10, wherein the machine readable instructions are executable by the at least one processor to:
terminate the second interface session in response to receiving a termination request for the first interface session or in response to a time out of the first interface session.

15. A method comprising:
establishing a first interface session between a UPM system and a PEP;
establishing a second interface session between the UPM system and a PDP residing on a computer system external to the UPM system;
receiving, from the PEP via the first interface session, event information associated with network traffic received at the PEP;
sending the event information to the legacy PDP via the second interface session;
receiving a policy decision from the legacy PDP; and
determining, based on the event information, whether to forward the policy decision to the PEP, to ignore the policy decision or to modify the policy decision.
